(19) United States
(12) Patent Application Publication
(10) Pub. No.: US 2010/0163347 A1
(43) Pub. Date: Jul. 1, 2010

(54) ELEVATOR ARRANGEMENT AND METHOD

(76) Inventors: Gert VAN DER MEIJDEN, Otterlo (NL); Jos VAN DER HEUVEL, 's-Hertogenbosch (NL)

Correspondence Address: BIRCH STEWART KOLASCH & BIRCH, PO BOX 747, FALLS CHURCH, VA, 22040-0747, US

(21) Appl. No.: 12/721,229

(22) Filed: Mar. 10, 2010

Related U.S. Application Data
(63) Continuation of application No. PCT/FI2008/000100, filed on Sep. 11, 2008.

(30) Foreign Application Priority Data
Sep. 11, 2007 (FI) 20070694

(51) Int. Cl. B66B 7/06; B66B 11/08

(52) U.S. Cl. 187/254

(57) ABSTRACT

Arrangement and method for the construction-time use of an elevator, which arrangement comprises an elevator car (2), hoisting roping (4), a hoisting machine fitted to move the elevator car via the hoisting roping (4), which hoisting machine is preferably disposed on the machine room level (22) at the top end of the elevator hoistway, a counterweight (56), and which elevator comprises compensating roping (10), which compensating roping is connected to the supply storage (16) of the compensating roping. In the arrangement, the compensating roping (10) is connected to the elevator car via a diverting pulley (28) on the elevator car and to the counterweight (56) via a diverting pulley (58) on the counterweight (56). In the method one or more jumps of the machine room level are performed, and the additional rope needed for a jump of the machine room level is taken from the supply storage of the compensating roping. The construction-time roping of the elevator is arranged such that the compensating roping is connected to the elevator car (2) via the diverting pulley (28) on the elevator car (2) and to the counterweight (56) via the diverting pulley (58) on the counterweight (56).

### FIELD OF THE INVENTION

The present invention relates to an elevator arrangement for the construction-time use of the elevator as defined in the preamble of claim 1 and a method in the building of the elevator as defined in the preamble of claim 15.

### BACKGROUND OF THE INVENTION

When constructing high-rise buildings, elevators are needed before the building has been completed. Elevators are either needed for operation during construction, or when the lower floors are finished earlier than the rest, in which case the elevators serving them have to be available for use. As the construction work progresses the elevator must be capable of serving the highest possible floor levels.

So-called jump lifts, in which the travel height of the elevator is increased in a stepwise manner as the construction work is progressing, have been developed for construction-time use. The elevator machine room is moved to a higher floor and the length of the hoisting rope in use is increased accordingly. It is generally required that the elevator should be available for use in its entirety and with all its properties. Therefore, other components depending on the travel height, such as car cables, compensating ropes, overspeed governors and hoistway electrification and hoistway cables should be extended over the entire length of the finished hoistway.

Earlier solutions are known in which the required additional length of the elevator hoisting rope in a jump lift is taken from a rope storage. This kind of solution for the construction-time use of an elevator is presented in publication JP 7-9715. In this solution the elevator ropes are fitted to pass from the elevator car to the traction sheave that is in connection with the hoisting machine and from there to the machine room level via the diverting pulley arranged for the counterweight, after which the elevator rope is arranged to pass to the rope storage outside the hoistway. This solution does not include any kind of arrangement for compensating the hoisting rope masses.

Compensation of the rope masses of the hoisting roping is conventionally arranged with a chain in jump lifts, because the length of the chain can be increased by attaching the required length of chain links to the chain already in use. A chain structure, however, has proven to be disadvantageous because, among other things, it limits the operating speed of the elevator.

A few of the types of solutions in which it is proposed that the addition to the compensating mass required for the jump lift is arranged with a metal rope are also known from prior art. The solution of our publication WO 00/50328 proposes that the addition of the length of the roping is taken from a rope storage, which publication presents an elevator that moves the elevator car with a suspension ratio of 1:1, which is intended for construction-time use. A problem of the solution is the great tension of the compensating ropes to be directed into the rope storage, for which reason the openable clamps must be dimensioned to be large. One problem of the elevator in question is also that the counterweight makes a shorter backwards and forwards movement than the elevator car. This, among other things, hampers the balancing of the compensating roping with the masses of the hoisting roping in connection with a jump lift, because in connection with a jump lift the area of movement of the counterweight increases by only one-half of the length of the jump and the area of movement of the car increases by the distance of the jump. For this reason the area of movement of the counterweight must be shifted/adjusted after the jump if it is desired to preserve the position of equilibrium prevailing before the jump. In addition, a problem in the solution presented has been that the selection options for the rope supply location are very limited.

### PURPOSE OF THE INVENTION

The purpose of the invention is to eliminate the aforementioned drawbacks of prior-art elevators. The purpose of the invention is to implement an elevator arrangement, which is able to provide one or more of the following advantages, among others:
With the arrangement according to the invention, the increase of rope length required as the height of the building increases is easy to implement.
The tensioning forces of the rope clamps of the compensating ropes can be formed to be smaller than earlier.
The hoisting ropes and the compensating ropes are immediately in a position of equilibrium when moving to the new operating level.
The force exerted on the rope clamps used as an aid for the addition of rope length can be reduced by means of a reduction in rope tension. Additionally, a weaker tension is exerted on the individual rope clamps in the jump of the elevator car. That being the case the rope clamps can, among other things, be dimensioned for smaller forces than before and they can be manufactured more inexpensively and more simply.
The parts of the hoisting rope and of the compensating rope which are not yet in use can be freely disposed in a suitable place, even in a space outside the building.
In the construction-time roping elevator car and the counterweight make a backwards and forwards movement of the same length as each other, in which case in a jump lift situation the counterweight can be driven down to the bottom and the car rises to the level of the new lifting height, in which case the correct rope lengths match.
An arrangement and a method are achieved with which the rope addition needed is safe and easy to provide owing to the reduced rope tensions.
A simple, easy-to-use and safe method, in terms of its rope addition, is achieved in the construction of high-rise/express elevators without the rope speeds of the finished elevator becoming disadvantageously large.
An arrangement and a method are achieved in which the construction-time roping of an elevator can be formed to be lighter than the final roping of the elevator.

The purpose of the present invention is to achieve an elevator for construction-time use, which in particular is inexpensive and safe in terms of its compensating roping arrangement, and which can easily be raised to a higher operating level as the construction work progresses.

### SUMMARY OF THE INVENTION

The elevator arrangement according to the invention is characterized by what is disclosed in the characterization part of claim 1. The method according to the invention is characterized by what is disclosed in the characterization part of claim 15. Other embodiments of the invention are characterized by what is disclosed in the other claims. Some inventive embodiments are also discussed in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the scope of the basic inventive concept in conjunction with other embodiments.

The arrangement according to the invention for the construction-time use of an elevator comprises an elevator car, hoisting roping, a hoisting machine fitted to move the elevator car via the hoisting roping, which hoisting machine is preferably disposed on the machine room level at the top end of the elevator hoistway, a counterweight, and which elevator comprises compensating roping, which compensating roping is connected to the supply storage of the compensating roping. In the arrangement, the compensating roping is connected to the elevator car via a diverting pulley on the elevator car and to the counterweight via a diverting pulley on the counterweight. With the compensating roping in question, possessing 2:1 roping, the force exerted on the rope clamps used for the addition of rope length required by the increase of travel height can be reduced. That being the case the reliability of the rope clamps can be improved and they can be dimensioned to withstand smaller forces than earlier. In this way it is also possible to select the rope supply location best suited for the situation on a case-by-case basis.

In the arrangement according to one embodiment of the invention the compensating roping is fixed in the elevator hoistway, preferably in the bottom part of it, to a first clamp of the compensating roping and is arranged to pass via the diverting pulley arranged in connection with the elevator car to a second clamp in the hoistway or on another solid part of the building, and the compensating roping is directed to pass from the clamp to the supply storage of the compensating roping.

In the method in the building of an elevator, which elevator comprises an elevator car, hoisting roping, a hoisting machine fitted to move the elevator car via the hoisting roping, which hoisting machine is preferably disposed on the machine room level at the top end of the elevator hoistway, a counterweight, compensating roping, which compensating roping is fixed with a rope clamp, via which the compensating roping is connected to the supply storage of the compensating roping, one or more jumps of the machine room level are performed, and the additional rope needed for the jump of the machine room level is taken from the supply storage of the compensating roping. In the method the construction-time roping of the elevator is arranged such that the compensating roping is connected to the elevator car via a diverting pulley on the elevator car and to the counterweight via a diverting pulley on the counterweight. With the method (owing to the 2:1 roping) the force exerted on the rope clamps used for the addition of rope length required by the increase of travel height can be reduced. That being the case the reliability of the rope clamps can be improved and they can be dimensioned to withstand smaller forces than earlier. In this way it is also possible to select the rope supply location best suited for the situation on a case-by-case basis.

In the method according to one embodiment of the invention the roping of the elevator is converted to form the final roping of the elevator by arranging the ropings of the elevator so that both the hoisting roping and the compensating roping are connected at their first end to the counterweight and at their other end to the elevator car. Thus a 1:1 elevator is achieved, which is suited as an express elevator, without compromising construction-time safety, the smoothness of rope supplies or the smoothness of jump lifts generally.

### LIST OF FIGURES

In the following, the invention will be described in detail by the aid of some embodiments with reference to the attached drawings, wherein

FIG. 1 presents a diagrammatic and isometric view of one embodiment of the elevator arrangement according to the invention.

FIG. 2 presents a diagrammatic view of one embodiment of the elevator arrangement according to the invention.

FIG. 3 presents a final elevator arrangement, into which the construction-time elevator arrangement in the method according to the invention is converted.

### DETAILED DESCRIPTION OF THE INVENTION

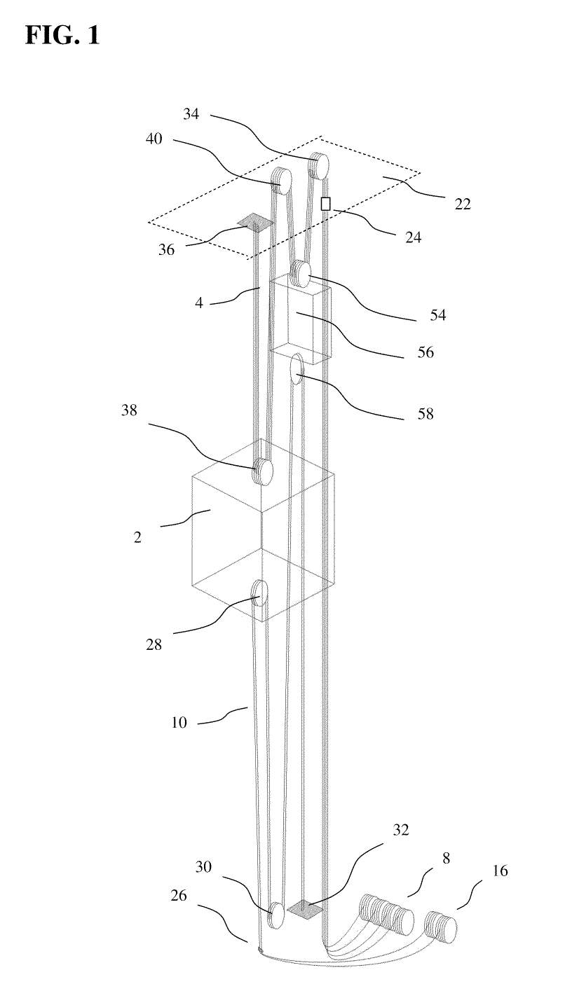

FIG. 1 presents an elevator arrangement according to one preferred embodiment of the invention. The figure is diagrammatic and only the most essential parts of the invention are presented in it. A machine room level 22 is fixed to the top part of the elevator hoistway (not shown) in a manner known in connection with jump lifts, in which machine room level the hoisting machine of the elevator is installed. Machine room level refers to the structure, e.g. a lattice structure comprised of metal beams, in the elevator hoistway that handles the tasks of a machine room. In the figures the machine room level 22 is described with a dashed line, above which dashed line the drawn parts are fixed to the machine room level 22. The hoisting machine comprises an elevator motor, with any possible gears, and the traction sheave 40 rotated by it. The hoisting roping 4 of the elevator is fixed in connection with the machine room level 22 with a first clamp 36 and is fitted to pass up via the diverting pulley 38 of the elevator car 2 and from there over the traction sheave and at the point of the traction sheave to change its direction downwards and to pass to the counterweight. The hoisting roping 4 passes from there via the diverting pulley 54 on the top part of the counterweight 56 back to the machine room level 22, to which the hoisting roping 4 is fixed with a second clamp 24 after it has first passed over the diverting pulley 34. The diverting pulley 34 could alternatively be on the other side of the clamp 24. From the clamp 24 the hoisting roping passes from there along the edge of the elevator hoistway or corresponding to the bottom part of the elevator hoistway and to the rope supply storage 8. This means that the roping 4 is in connection with the rope supply storage 8. In this context, any statement that the roping passes or the rope is directed to pass refers to the location or placement of the rope in relation to other components of the elevator, and not to the direction of movement of the rope.

The compensating roping 10 is directed from the first clamp 32 of the compensating roping in the bottom part of the hoistway to the diverting pulley 58 fixed to the bottom part of the counterweight and via it onwards to the diverting pulley 30 fixed to the bottom part of the elevator hoistway, via which diverting pulley 30 the compensating roping 10 is directed to the diverting pulley 28 fixed to the car 2, over which diverting pulley 28 the compensating roping is directed to the second clamp 26 of the compensating roping that is in connection with the hoistway or the other structures of the building. From the rope clamp 26 the compensating roping is directed to pass onwards to the supply storage 16 of the compensating rope. Thus the excess compensating roping behind the clamp 26 is stored on the reels of the rope supply storage 16. Correspondingly the part of the hoisting roping 4 of the elevator which is not in construction-time use is out of use on the other side of the clamp 24 such that surplus slack roping is reeled onto the reels of the rope supply storage 8. The rope supply storage 16 and the rope supply storage 8 are located in the figures in the bottom part of the building below the level of the machine room level 22. It is also advantageous to dispose the rope supply storage 16 and/or the rope supply storage 8 outside the hoistway. The clamps 24 and 26 in the embodiment of FIG. 1 are mechanical clamps that can be opened and tightened, into which the ropings 10 and 4 currently in use, both of which comprise one rope or a plurality of ropes, can be locked without cutting the rope, such that each rope of the roping passes via its clamp intact at least up to the rope supply storage. The compensating roping 10 and the hoisting roping 4 of the elevator are both fixed to both the elevator car 2 and the counterweight 56 with a 2:1 suspension ratio. In the embodiment of FIG. 1 the diverting pulleys 30 and 34 as well as the traction sheave 40 are installed in the elevator hoistway in a stationary location with respect to the elevator hoistway. Preferably at least a part or all of the diverting pulleys 28, 30, 38, 34, and 58 comprise bearings allowing rotation. It is also advantageous to arrange for at least the diverting pulley 30 to move in the vertical direction, so that the compensating rope can be loosened in connection with a jump lift.

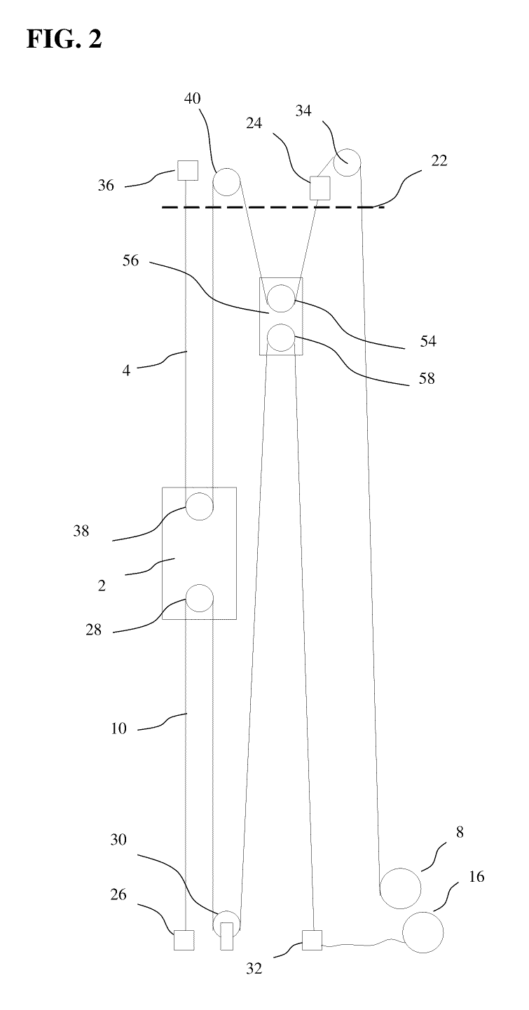

In the arrangement of FIG. 1 the rope of the rope supply storage 16 can be supplied to the elevator arrangement via the first clamp 26 of the compensating roping. However, the invention can also be applied in the manner illustrated by FIG. 2, where the rope of the rope supply storage can be supplied via the second clamp 32 of the compensating roping. In this case the second clamp 32 of the compensating roping is a mechanical clamp that can be opened and tightened in the manner described earlier. The compensating roping 10 is in this case directed from the clamp 26 in the bottom part of the hoistway to the diverting pulley fixed to the elevator car and via it onwards to the diverting pulley 30 fixed to the bottom part of the elevator hoistway, via which diverting pulley 30 the compensating roping 10 is directed to the diverting pulley fixed to the bottom part of the counterweight 56, over which diverting pulley 58 the compensating roping is directed to the second rope clamp 32 of the compensating roping that is in the hoistway or in connection with the other structures of the building, to which the compensating roping is fixed in a way that can be opened and via which the compensating roping is directed from the rope clamp onwards to the storage 16 of the compensating roping. Also illustrated in FIG. 2 is a feature of one embodiment of the invention, in which the hoisting roping 4 of the elevator passes from the diverting pulley 54 of the counterweight directly to the second clamp 24 of the hoisting roping on the machine room level. In other respects the arrangement illustrated in FIG. 2 corresponds to the arrangement of FIG. 1. FIG. 2 illustrates the principle of the invention as a simplified side view. The paths of passage of the ropings, elevator car and counterweight are in practice preferably arranged to overlap in the elevator hoistway, e.g. in the manner described in the solution of FIG. 1. The parts of the equipment fixed in connection with the machine room level 22 are drawn in the figures above the dashed line depicting the machine room level. In the embodiment presented in FIG. 2 as well as in FIG. 1 the elevator hoistway or corresponding surrounds the machinery of the elevator in some way that is prior art. The rope supply storages 8 and 16 can be at least partly inside or outside the hoistway or corresponding.

The jump-time lengthening of the rope of the overspeed governor is implemented preferably in a corresponding manner to the lengthening of the hoisting ropes and the compensating ropes. The rope of the overspeed governor can be fixed to the clamp on the roof of the car and the excess part of the rope can be stored in the rope supply storage of the overspeed governor on the roof of the car. Correspondingly, for the purposes of the future travel heights, it is advantageous to arrange on the machine room level 22 a car cable storage and a hoistway cabling storage for the hoistway wiring. It is advantageous to arrange a space for the control panel or for the elevator control unit on the machine room level or in its proximity such that they can be lifted together when the machine room level 22 is raised upwards as the construction work progresses.

When the machine room level of the elevator must be raised to the next level, the procedure described below is preferably followed. The elevator car is driven with service drive to the highest possible location. The counterweight is in this case at the bottom and it is supported and locked into its position. After this the car is supported in its position e.g. by locking it to the guide rails or with some other reliable method. The rope clamps on the side of the rope supply storage of the hoisting roping and the compensating roping are detached, in which case the addition of rope required can be supplied from the rope supply storage. The fixing of the rope of the overspeed governor is released, so that the rope of the overspeed governor can slip during the lift of the machine room. The wiring connected to the control panel of the elevator is detached.

The machine room level of the elevator and its support beams are raised slightly with a crane or construction hoist (not shown), in which case the support means of the machine room level structure can be detached. The machine room level is lifted to the next level with the hoist or with some other suitable lifting method. During the lifting the hoisting roping and the compensating roping pass freely from the reels of the rope supply storages. Likewise, the rope of the overspeed governor runs from the rope reel of the overspeed governor on the roof of the elevator car. Correspondingly, the corresponding amount of car cable and hoistway cable is released from the car cable reels and hoistway cable reels on the machine room level.

After the lift of the machine room level the support means of the machine room are activated and the support beams of the machine room are supported reliably on the building. The rope of the overspeed governor is fixed to the roof of the car. The elevator car is lifted to the higher level with a hoist or crane, after which the hoisting roping and the compensating roping are tightened to the correct tension and locked in their positions with clamps. The counterweight is released and the car cables and hoistway cables are fixed and connected to the control panel. After this the elevator is ready to serve the new floors.

When the building has reached its final height the construction-time machine room level together with the hoisting machine and other machine room appliances can, if so desired, remain there permanently, in which case they comprise the corresponding part of the final machine room. The rope supply storages and the other means belonging to construction-time activities are, of course, removed as they are not needed.

In the embodiments of the figures the first clamp 36 of the hoisting roping is in connection with the machine room level 22. One advantage in this case is that the used length of the hoisting roping of the elevator can be greatly increased in connection with a jump of the machine room level, because the fixing point rises with the machine room level 22 and pulls the rope from the rope supply storage 8 when the second clamp 24 of the hoisting roping is opened. Alternatively the first clamp 36 of the hoisting roping can be fixed to the elevator hoistway.

In the embodiments presented in the figures the second clamp 24 of the hoisting roping is in connection with the machine room level 22. The advantage of this is that the clamp 24 can be used from the machine room level 22. Alternatively, the clamp 24 can be in connection with the elevator hoistway, in which case an advantage is that the fixing point stays in position during a jump-lift and the employee can make the opening and the tightening after the jump-lift in the same place safely. In this case the presence of the diverting pulley 34 is preferred so that the roping is able to run without problems via the machine room level.

According to one embodiment the hoisting roping 4 of the elevator is arranged to be lengthened by supplying it via the first clamp 36 of the hoisting roping. In this case the difference to the embodiments of FIGS. 1 and 2 is, among others, that the roping 4 is directed from the supply storage 8 of the hoisting rope to the clamp 36 instead of to the clamp 24. In this case it is also advantageous to arrange a diverting pulley for the machine room level 22, via which the roping coming from the diverting pulley 38 is able to pass to the rope supply storage 8. In this case the second end of the hoisting roping 4 is preferably fixed to the machine room level 22. Of course, both ends of the hoisting roping 4 can be directed to the rope supply storage, in which case the second end is directed to the rope supply storage via the clamp 24 in the manner presented in the figures.

In the method according to the invention one or more jumps of the machine room level are performed preferably in the manner described earlier, and the additional rope needed for a jump of the machine room level is taken from the supply storage of the compensating roping 16. In the method the construction-time roping of the elevator is arranged such that the compensating roping is connected to the elevator car 2 via a diverting pulley 28 on the elevator car 2 and to the counterweight (56) via a diverting pulley (58) on the counterweight (56). In this way, the stress exerted on the rope clamps, among other things, can be reduced. The rope addition can also be performed via both clamps in any way whatsoever that is best suited to each elevator arrangement. The opportunity of selection for the specific case is advantageous because different types of solutions generally have both good and bad aspects, which depend on the situation. The freedom of choice is advantageous because, among other things, the additional amount of rope runs through the whole suspension arrangement during the addition. A problem with supplying rope from the side of the counterweight is that the rope runs through the whole suspension arrangement during the addition. On the other hand, an advantage is that the clamp 32 is easy and safe to open without moving below the car in its lifted position or into a dangerous area from the viewpoint of falling tools. At best this can be performed without moving into the elevator hoistway at all because owing to the placement of the counterweight, with the easy arrangement it is always easy to position the clamp in the edge area of the elevator hoistway near the reels 16. An advantage in supplying rope via the clamp 26 is that the supply of the new rope can be arranged to occur such that not all the compensating roping needs to run when adding rope but instead only the rope between the car and the clamp 26 moves. Thus, among other things, the rope tensions are easy to maintain by locking the part of the rope in place during the jump into position (e.g. in FIG. 1, the roping 10 can be locked to the diverting pulley 30), and the part of the rope not in place is able to slacken during the lifting and the risk of ropes jumping off the diverting pulleys or otherwise causing problems with their swaying is avoided. Tightening after the jump is also in this case easy to perform. On the other hand, the placement of the clamp 26 in some situations can be awkward to perform such that it can be achieved safely.

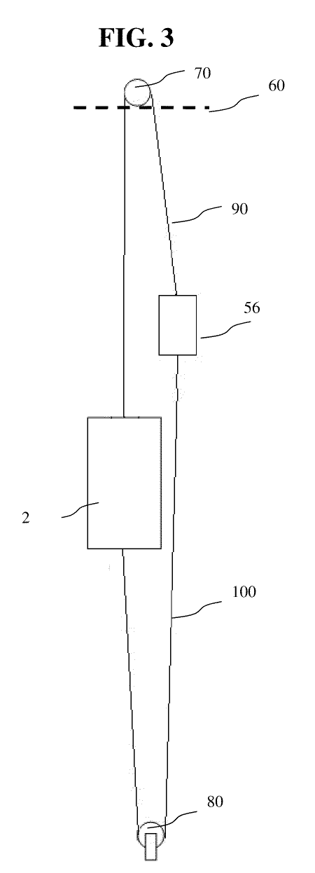

In the method the construction-time roping is additionally arranged preferably such that also the hoisting roping 4 is connected to the elevator car 2 via the diverting pulley 38 on the elevator car 2. In the method according to the invention, however, the roping of the elevator is converted after the jump lifts by arranging the ropings of the elevator so that the ends of the hoisting ropes and/or the compensating ropes are fixed to the elevator car. Preferably the roping of the elevator is converted to form the final roping of the elevator by arranging the ropings of the elevator so that both the hoisting roping and the compensating roping are connected at their first end to the counterweight and at their other end to the elevator car according to FIG. 3. In this way the rope speeds of the finished elevator can be reduced and the elevator speeds can be increased. The construction-time roping of the elevator can also with the method described be formed to be lighter (thin ropes) than the final roping of the elevator, firstly because of the lower tensile stresses and secondly from lower speed, car loads and a smaller travel height.

FIG. 3 presents an elevator arrangement, preferably a high-rise elevator, into which the elevator arrangement in the method according to the invention is converted. The elevator arrangement is converted so as to be provided with a 1:1 hoisting ratio, in which case the car 2 is moved with the hoisting roping 90 and with the machine 70 in the machine room 60. The ends of the hoisting ropes 90 are also fixed to the elevator car 2 and to the counterweight 56. In the arrangement the ends of the compensating ropes 100 are fixed to the elevator car and to the counterweight and pass around the diverting pulley in the bottom part of the hoistway.

Numerous implementation options exist for supporting the car and the counterweight during a jump of the machine room. Likewise the jump of the machine room and the jump of the car can be implemented in many alternative ways. Locking of the ropes during construction-time use can also in practice be performed with many methods. Likewise the supply of rope from the rope supply storages can be arranged in different ways. The place of the rope supply storage can be selected in each construction site according to the opportunities available.

In practice the machine room level can comprise beams and other corresponding support structures, which do not together necessarily form a continuous plane but instead the structures can extend so high in the vertical direction that they form a frame-like support structure. Thus the parts fixed in connection with the machine room level drawn in the figures above the machine room level 22, such as e.g. the diverting pulleys or the clamps, can be disposed such that they can be positioned in the vertical direction partly or wholly in the area defined by the machine room level or possibly below and/or above the machine room level. The fixing is, however, most preferably performed such that the parts fixed in connection with the machine room level rise along with the machine room level 22 in connection with the jump-lift. It is also obvious that each roping can comprise one rope or a plurality of ropes. It is also obvious that the diverting pulleys can also be disposed within the scope of the inventive concept otherwise to what is presented in the figures. For example, the diverting pulleys 54 and 58 of the counterweight do not necessarily need to be above and below the counterweight. Neither is the presence of the diverting pulley completely necessary, e.g. in an embodiment in which the clamp 24 is fixed to the level 22. In this type of embodiment the hoisting roping 4 can be directed directly from the diverting pulley 54 to the clamp 24 in the manner presented in FIG. 2 but however directed from the clamp 24 directly to the rope storage 8. It is also obvious that there can be more diverting pulleys in addition to the diverting pulleys presented in the figures, e.g. directing the ropings to follow preferred paths. It is also obvious that the invention can be utilized with a solution in which both ends of the hoisting roping and/or the compensating roping are arranged to continue via their clamps to the rope storage, in which case both the clamps of the roping in question can be opened and closed. It is also obvious that the openable and closeable mechanical clamp can be any prior-art clamp whatsoever that is capable of locking the rope without damaging it. The rope can be arranged to be tightened so as to be immovable, e.g. with a clamp provided with threads. It is also obvious that the hoisting roping alternatives and the compensating roping alternatives presented in this application can be combined with each other.

It is obvious to the person skilled in the art that the invention is not limited to the embodiments described above, in which the invention is described using examples, but that many adaptations and different embodiments of the invention are possible within the scope of the inventive concept defined by the claims presented below.

1. Arrangement for the construction-time use of an elevator, which arrangement comprises an elevator car, hoisting roping, a hoisting machine fitted to move the elevator car via the hoisting roping, which hoisting machine is preferably disposed on the machine room level at the top end of the elevator hoistway, a counterweight, and which elevator comprises compensating roping, which compensating roping is connected to the supply storage of the compensating roping, wherein the compensating roping is connected to the elevator car via a diverting pulley on the elevator car and to the counterweight via a diverting pulley on the counterweight.

2. Arrangement according to claim 1, wherein the compensating roping is fixed in the elevator hoistway, preferably in the bottom part of it, to a first clamp of the compensating roping and is arranged to pass via the diverting pulley arranged in connection with the elevator car to a second clamp in the hoistway or on another solid part of the building, and in that the compensating roping is directed from the clamp to pass to the supply storage of the compensating roping.

3. Arrangement according to claim 1, wherein the hoisting roping is connected to a supply storage of the hoisting roping.

4. Arrangement according to claim 1, wherein the hoisting roping is connected to the elevator car via a diverting pulley on the elevator car and to the counterweight via a diverting pulley on the counterweight.

5. Arrangement according to claim 1, wherein the compensating roping and the hoisting roping are connected to the elevator car and to the counterweight with a 2:1 suspension ratio.

6. Arrangement according to claim 1, wherein in the arrangement the hoisting roping of the elevator is fixed in connection with the machine room level or to a first clamp of the hoisting roping that is fixed in the elevator hoistway, and is fitted to pass via the diverting pulley that is in connection with the elevator car to the traction sheave that is in connection with the hoisting machine, and from here over the traction sheave via the diverting pulley arranged for the counterweight back to the machine room level and from there to the second rope clamp of the hoisting roping, and the hoisting roping is arranged to pass from the first clamp and/or from the second rope clamp of the hoisting roping to the supply storage of the hoisting roping, and in that the compensating roping is fixed to the first clamp of the compensating roping in the bottom part of the elevator hoistway and arranged to pass via the diverting pulley arranged in connection with the elevator car to the diverting pulley in the bottom part of the elevator hoistway and from there to the diverting pulley on the counterweight and from there to the second clamp of the compensating roping in the elevator hoistway or on another solid structure of the building, and in that the compensating roping passes from the first clamp or from the second clamp of the compensating roping to the supply storage of the compensating roping.

7. Arrangement according to claim 1, wherein the rope supply storage of the compensating rope and/or the rope supply storage of the hoisting rope is outside the hoistway.

8. Arrangement according to claim 1, wherein the rope supply storage of the compensating rope and/or of the hoisting rope is disposed below the machine room level.

9. Arrangement according to claim 1, wherein the amount of rope required for the jump of the machine room level is arranged to be supplied from rope supply storages.

10. Arrangement according to claim 1, wherein the machine room level is supported on the building.

11. Arrangement according to claim 1, wherein when the building is at its final height the machine room level comprises a machine room or a part of a machine room.

12. Arrangement according to claim 1, wherein the rope supply storage of the hoisting roping is disposed on the machine room level.

13. Arrangement according to claim 1, wherein the first clamp and/or the second clamp of the hoisting roping is fixed to the machine room level.

14. Arrangement according to claim 1, wherein the first clamp and/or the second clamp of the hoisting roping is fixed to the hoistway or to some other solid structure of the building.

15. Method in the building of an elevator, which elevator comprises an elevator car, hoisting roping, a hoisting machine fitted to move the elevator car via the hoisting roping, which hoisting machine is preferably disposed on the machine room level at the top end of the elevator hoistway, a counterweight, compensating roping, which compensating roping is fixed with a rope clamp, via which the compensating roping is connected to the supply storage of the compensating roping, and in which method one or more jumps of the machine room level are performed, and the additional rope of the compensating roping needed for the jump of the machine room level is taken from the supply storage of the compensating roping, wherein the construction-time roping of the elevator is arranged so that the compensating roping is connected to the elevator car via a diverting pulley on the elevator car and to the counterweight via a diverting pulley on the counterweight.

16. Method according to claim 15, wherein in the method the construction-time roping of the elevator is arranged such that the hoisting roping is connected to the elevator car via the diverting pulley on the elevator car.

17. Method according to claim 15, wherein the roping of the elevator is converted by arranging the ropings of the elevator so that the ends of the hoisting ropes and/or of the compensating ropes are fixed to the elevator car.

18. Method to claim 15, wherein the roping of the elevator is converted to form the final roping of the elevator by arranging the ropings of the elevator so that both the hoisting roping and the compensating roping are connected at their first end to the counterweight and at their other end to the elevator car.

19. Arrangement according to claim 2, wherein the hoisting roping is connected to a supply storage of the hoisting roping.

20. Arrangement according to claim 2, wherein the hoisting roping is connected to the elevator car via a diverting pulley on the elevator car and to the counterweight via a diverting pulley on the counterweight.
